(19) United States
(12) Patent Application Publication
(10) Pub. No.: US 2009/0234873 A1
(43) Pub. Date: Sep. 17, 2009

(54) METHOD AND SYSTEM FOR IMPLANT RECORD INTAKE USING A UNIQUE IMPLANT ID

(76) Inventors: Ming Li, San Diego, CA (US); Claudia Russell, San Diego, CA (US); Sam Eubanks, Leesburg, VA (US); Lee Smith, Spotsylvania, VA (US)

Correspondence Address: McDermott Will & Emery LLP, 11682 EL CAMINO REAL, SUITE 400, SAN DIEGO, CA, 92130-2047, US

(21) Appl. No.: 12/047,137

(22) Filed: Mar. 12, 2008

(51) Int. Cl. G06F 17/30

(52) U.S. Cl. 707/102; 707/E17.001

(57) ABSTRACT

A method and system for implant record intake using a unique implant ID include inputting to a database a lot number of a tissue, corresponding to a donor of the tissue. A unique serial number is assigned to the tissue and the unique implant ID is created using the lot number and the serial number. A barcode encoded with the unique implant ID may be generated and affixed to a container of the tissue. Further, information about the tissue, input at one or a plurality of user terminals, is associated with the unique implant ID in the database to create a searchable electronic record.

### FIELD

The present disclosure relates generally to the automated management of tissue information, and more particularly, a method and system for implant record intake using a unique implant ID.

### BACKGROUND

The Joint Commission on Accreditation of Healthcare Organizations (JCAHO) delineates multiple requirements regarding storage and maintenance of tissue and biologics. As a requirement for accreditation, records must be kept and updated at prescribed times to document the continuous monitoring of tissue.

The JCAHO requires a healthcare facility to implement standardized procedures to acquire, receive, store and issue tissues. For example, continuous temperature monitoring for refrigerators and freezers must be performed and documented. Records must be kept daily to show that a tissue was stored at the required temperature (e.g., 15°-30° C.). Further, all hospital records, including storage records of the tissue and all superseding procedures, are required to be kept for a minimum of 10 years.

Conventionally, doctors and healthcare facility staff manually record and update storage and maintenance information of tissue, using handwritten notes on a document affixed to a container holding the tissue. Merely recording such information on a single document, may result in missing documentation required by the JCAHO due to unintentionally overlooking tissue information or forgetting to monitor storage conditions, as well as human error occurring during the documentation. Missing and inaccurate records can result in tissue spoilage and/or endangering a patient by implanting contaminated tissue.

Moreover, in healthcare facilities, determining the location of a tissue may be difficult if the doctor or healthcare facility staff member is unaware of the current location of the tissue. As a result, it may be unnecessarily time-consuming for a user to update storage and maintenance information or to find the tissue to prepare it for implantation when the current location of the tissue is unknown.

### SUMMARY

The presently disclosed embodiments are directed to solving one or more of the problems presented in the prior art, described above, as well as providing additional features that will become readily apparent by reference to the following detailed description when taken in conjunction with the accompanying drawings.

One or more aspects of the present disclosure are directed to a method for implant record intake using a unique implant ID. The method comprises inputting to a database a lot number of a tissue, corresponding to a donor of the tissue; assigning a unique serial number to the tissue; and creating the unique implant ID using the lot number and the serial number. Once the unique implant ID is created a barcode may be generated, with the unique implant ID, and affixed to a container of the tissue.

One or more other aspects of the present disclosure are directed to a system for implant record intake using a unique implant ID. The system comprises one or a plurality of user terminals to input to a database a lot number of a tissue, corresponding to a donor of the tissue; and a processing unit to assign a unique serial number to the tissue, and to create the unique implant ID using the lot number and the serial number. Once the unique implant ID is created a barcode may be generated, with the unique implant ID, and affixed to a container of the tissue.

One or more aspects of the present disclosure are directed to a computer-readable medium storing instructions thereof for performing a method of implant record intake using a unique implant ID. The method comprises inputting to a database a lot number of a tissue, corresponding to a donor of the tissue; assigning a unique serial number to the tissue; and creating the unique implant ID using the lot number and the serial number. Once the unique implant ID is created a barcode may be generated, with the unique implant ID, and affixed to a container of the tissue.

As will become evident by the following Description and Drawings, implant record intake using a unique implant ID ensures data integrity and accuracy, thereby reducing tissue spoilage and providing improved patient safety with better clinical outcomes.

Of course, the present invention is not limited to the aforementioned embodiments, and other features of the embodiments will become apparent after review of the hereinafter set forth Brief Description of the Drawings, Detailed Description, and the Claims, or may be learned by practice of the invention.

### BRIEF DESCRIPTION OF THE DRAWINGS

The foregoing aspects of the embodiments described herein will become more readily apparent by reference to the following detailed description when taken in conjunction with the accompanying drawings wherein:

FIG. 1 is a graphical illustration of a system for implant record intake using a unique implant ID, according to one or more disclosed embodiments.

FIG. 2 is a flow diagram showing a method for implant record intake using a unique implant ID, according to one or more disclosed embodiments.

FIG. 3 is a flow diagram showing a method for updating tissue information using a unique implant ID, according to one or more disclosed embodiments.

FIG. 4 is a flow diagram showing a method for searching tissue information based on a unique implant ID, according to one or more disclosed embodiments.

FIG. 5 is a schematic of a tissue container with a machine readable label bearing a unique implant ID affixed thereto, according to one or more disclosed embodiments.

### DETAILED DESCRIPTION

Reference will now be made in detail to the presently disclosed embodiments, examples of which are illustrated in the accompanying drawings, wherein like reference numerals refer to like elements throughout.

In the following detailed description, numerous specific details are set forth to provide a full understanding of the subject technology. It will be obvious, however, to one ordinarily skilled in the art that the subject technology may be practiced without some of these specific details. In other instances, well-known structures and techniques have not been shown in detail so as not to obscure the subject technology.

Embodiments of the present disclosure address and solve problems related to tissue management, including that of maintaining the integrity of data records related to the tissue, which can be caused, for example, by failure to record, or attempting to maintain and secure manual documentation. These and other concerns are solved, at least in part, by embodiments of the present invention that provided, for example, a method and system for implant record intake using a unique implant ID. The method and system comprise inputting to a database a lot number of a tissue, corresponding to a donor of the tissue; assigning a unique serial number to the tissue; and creating the unique implant ID using the lot number and the serial number. Once the unique implant ID is created a barcode may be generated, with the unique implant ID, and affixed to a container of the tissue. As a result, data accuracy and integrity are maintained as electronic records are created and associated with the unique implant ID. In addition, clinicians can use one or more user terminals to monitor, for example, what tissue has arrived, the current location of the tissue, conditions of the tissue upon arrival, storage conditions and routing updates.

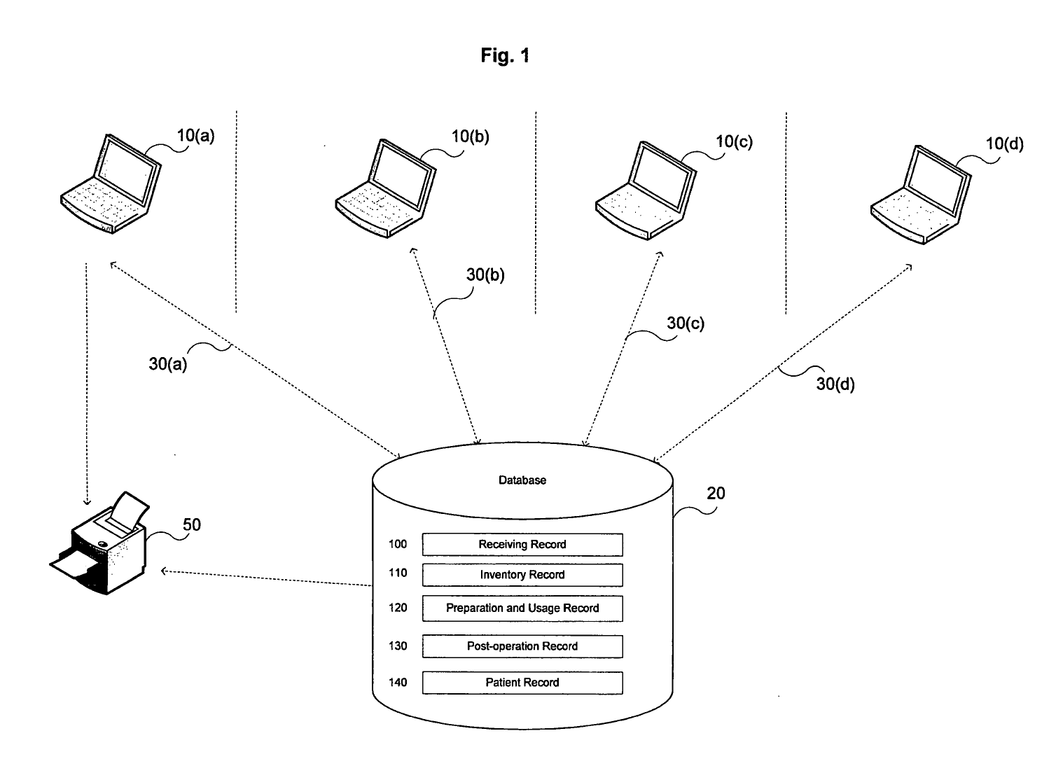

FIG. 1 is a graphical illustration of a system for automated management of tissue information, according to one or more disclosed embodiments. Upon receipt of tissue at an unloading dock or a tissue bank, for example, an electronic reception record 100 is established in a database 20 for the tissue via user terminal 10(a). A user (not shown) may be prompted at terminal 10(a) to enter a tissue lot number and type. According to certain aspects, the lot number corresponds to an identifier of a donor of the tissue.

In addition, the user may be prompted to enter into database 20 via user terminal 10(a) intake tissue information including an expiration date, a supplier name, necessary storage temperature, the date and time at which the tissue is received, the person receiving and/or inspecting the tissue, receipt of tissue testing results and/or the condition of the tissue upon arrival. Of course, the foregoing information entered into database 20 via user terminal 10(a) is merely exemplary and other information, as well as various combinations of the foregoing information, may be entered. Alternatively, vendor information as well as a facility item ID from the facility of the vendor may be provided directly via a national inventory database or a supplier database.

A processor (not shown) communicatively coupled to the database 20 generates a serial number that is unique to a particular tissue. Any conventional serial number generation process may be implemented without departing from the scope of the present disclosure, so long as the serial number is not assigned to another tissue having the same lot number. A unique implant ID is created by the processor using both the lot number and the unique serial number, in certain embodiments, and is associated with the intake tissue information within database 20. The unique implant ID can be created by a simple concatenation of the lot number and the unique serial number, for example. More complicated creation methods can also be used.

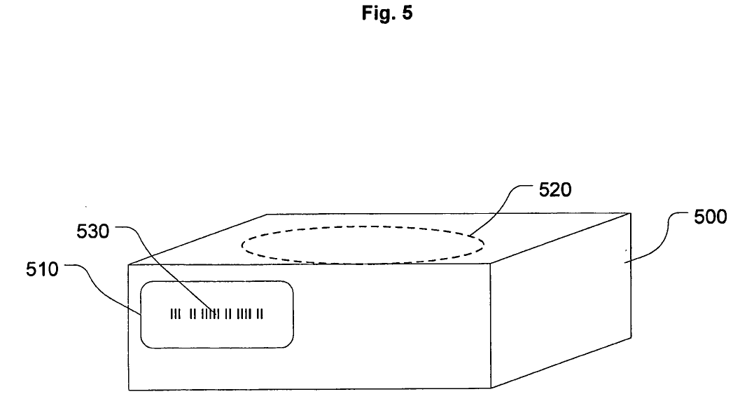

A user may request a barcode, for example, at terminal 10(a) using a barcode generator 50, which generates a barcode encoded with the unique implant ID obtained from database 20. The barcode may be affixed to a container packaging holding the tissue. Thereafter, a user may search for and retrieve any information associated with the tissue at any user terminal 10(a)-10(d) by scanning the barcode affixed to the container or packaging of the tissue. Any conventional system of barcode reading may be implemented within this scope of the present disclosure. (FIG. 5 and the corresponding description below provide further details).

It is noted that use of a barcode is used throughout the present disclosure for exemplary purposes. However, barcode generator 50 may be any machine readable label generator generating a machine readable label bearing the unique implant ID for the tissue. For example, the generated machine readable label may be a 3D barcode, a radio frequency identification (RFID) tag, a magnetically encoded tag, a chip etc.

According to certain embodiments, one or a plurality of user terminals 10(a) may be used to enter the intake tissue information. Each user terminal 10(a) may prompt a user to enter required intake tissue information and communicates the intake tissue information to database 20 via a connection 30(a), which may be a wireless connection (e.g., WiFi) or a hard-wired connection (e.g., a local area network). According to certain embodiments, the user terminal 10(a) is a device previously incorporated into a local area network and/or wireless local area network, complying with IEEE 802.11 standards. According to other embodiments, user terminal 10(a) may communicate with database 20 via the internet. Any conventional means of communication, however, may be employed between the user terminal 10(a) and database 20.

After receipt of the tissue, an inventory record 110, a preparation and usage record 120, a post-operation record 130 and a patient record 140 may be established in the database 20. Specific details of the automated management of tissue information are described in application Ser. No. 12/047,122, entitled “METHOD AND SYSTEM FOR AUTOMATED MANAGEMENT OF TISSUE INFORMATION”, with the same inventors as the present application and filed concurrently herewith, and which is expressly incorporated herein by reference. Tissue information stored in the inventory record 110, preparation and usage record 120, post-operation record 130 and patient record 140 will be associated with the unique implant ID within database 20. Thus, a user may search for any and all tissue information at a user terminal 10(a)-10(d) using the unique implant ID or by scanning the barcode affixed to the container or packaging of the tissue.

According to certain embodiments, for example, an inventory record 110 including inventory information may be established in database 20, which may include movement and acceptance information at various locations, dispensing information and storage conditions of the tissue. The storage temperature of the tissue may be obtained every 15 minutes using, for example, a wireless thermometer such as a G2 Snap Calibration Probe; however, any conventional temperature monitoring device may be employed. Inventory information may be input to the database 20 using one or a plurality of user terminals 10(b), which may be a procedure station that stores and monitors the storage temperature of the tissue automatically every 15 minutes, for example, and transmits the storage temperature to database 20.

Each user terminal 10(b) may prompt a user to input required inventory information, and communicates the inventory information to database 20 via a connection 30(b). According to certain embodiments, the user may periodically update the inventory record 110 at predetermined time intervals using one or more user terminals 10(b). In addition, the user may search for the inventory record 110 in the database 20 using the tissue ID or any other category of inventory information in order to check the status of the tissue.

Connection 30(b) may be a wireless connection (e.g., WiFi) or a hard-wired connection (e.g., a local area network). According to certain embodiments, the user terminal 10(b) is a device previously incorporated into a local area network and/or wireless local area network, complying with IEEE 802.11 standards. According to other embodiments, user terminal 10(b) may communicate with database 20 via the internet. Any conventional means of communication, however, may be employed between the user terminal 10(b) and database 20.

According to certain embodiments, a preparation and usage record 120 including preparation and usage information may be established before the tissue is implanted. The preparation information may include the date, the user, the preparation methodology including a reconstituting agent, ancillary materials and the condition of the tissue before implantation. The usage information may include the date, the patient the clinicians involved with implantation, procedure steps for the implantation and the condition of the tissue during implantation. Of course, these specific items of preparation and usage information are merely exemplary, and other information may be included.

Preparation and usage information may be entered at one or a plurality of user terminals 10(c), possibly located within an operating room. Each user terminal 10(c) may prompt a user to input required preparation and usage information and communicates the inventory information to database 20 via a connection 30(c), which may be a wireless connection (e.g., WiFi) or a hard-wired connection (e.g., a local area network). According to certain embodiments, the user terminal 10(c) is a device previously incorporated into a local area network and/or wireless local area network, complying with IEEE 802.11 standards. According to other embodiments, user terminal 10(c) may communicate with database 20 via the internet. Any conventional means of communication, however, may be employed between the user terminal 10(c) and database 20.

According to certain embodiments, a post-operation record 130 may be established following tissue implantation. The post-operation record 130 may include post-operative patient reaction information such as the patient name, medical record number, implanting physician, type of tissue implanted, date of implant, date of any adverse outcome, patient symptoms, name of person reporting adverse reaction, name of person obtaining the post-operative patient reaction information and the date the post-operative patient reaction information was obtained. The functionality of the implant should be tested to determined if an explant is necessary. Results of such tests also must be included in the post-operative patient reaction information. Of course, these items of information are merely exemplary, and additional information may be included without departing from the scope of the present disclosure.

Post-operative patient reaction information may be entered at one or a plurality of user terminals 10(d). Each user terminal 10(d) may prompt a user to input required post-operative patient reaction information and communicates the inventory information to database 20 via a connection 30(d), which may be a wireless connection (e.g., WiFi) or a hard-wired connection (e.g., a local area network). According to certain embodiments, the user terminal 10(d) is a device previously incorporated into a local area network and/or wireless local area network, complying with IEEE 802.11 standards. According to other embodiments, user terminal 10(d) may communicate with database 20 via the internet. Any conventional means of communication, however, may be employed between the user terminal 10(d) and database 20.

According to certain embodiments, a patient record 140 is created in database 20 which is associated with the unique implant along with the corresponding intake tissue information, inventory information, preparation information, and usage information of the tissue that is associated with a patient. Subsequently, the post-operative patient reaction information may be added to the patient record 140.

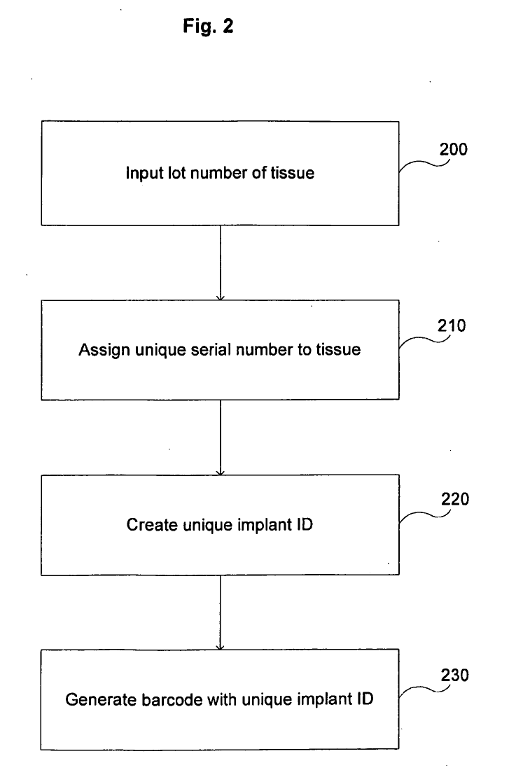

FIG. 2 is a flow diagram showing a method for implant record intake using a unique implant ID, according to one or more disclosed embodiments. At operation 200, a user inputs a lot number of a tissue upon receipt. The lot number corresponds to the identifier of a donor. The lot number may be provided by a supplier via a supplier database or a national inventory database, or may be provided to the user when the tissue arrives.

From operation 200, the process proceeds to operation 210, where a unique serial number is assigned to the tissue. Any conventional serial number generator may be employed using a processor communicatively coupled to database 20. The serial number must be unique to the particular tissue, in case more than one tissue is taken from a particular donor (i.e., one or more tissues may be taken with the same lot number).

From operation 210, the process proceeds to operation 220, where a unique implant ID is created based on both the lot number and the unique serial number. The unique implant ID is associated with all corresponding tissue information within database 20. According to certain embodiments, barcode generator 50 may generate a barcode at operation 230 using the unique implant ID, and the barcode may be affixed to a container or packaging of the tissue. Of course, use of a barcode is merely exemplary, and other machine readable labels bearing a unique identifier may be used, such as a 3D barcode, an RFID tag, magnetically encoded tag, a chip, etc. See FIG. 5 showing a schematic of a tissue container with a machine readable label bearing a unique implant ID affixed thereto, according to one or more disclosed embodiments.

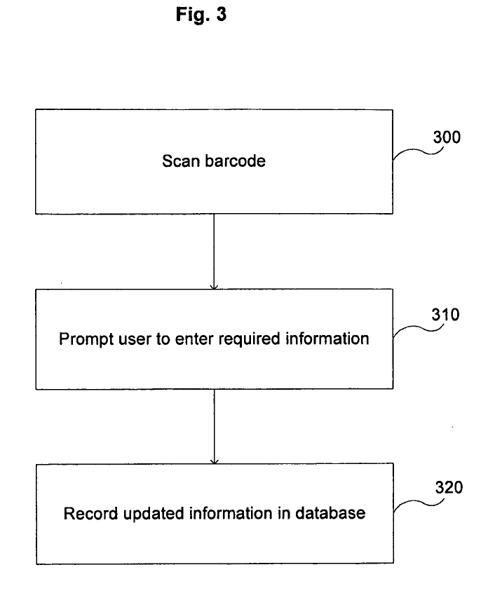

FIG. 3 is a flow diagram showing a method for updating tissue information using a unique implant ID, according to one or more disclosed embodiments. At operation 300, a user scans the barcode or other machine readable label bearing a unique identifier affixed to a container or packaging of the tissue using a conventional barcode reader. It is noted, however, that the user may alternatively input the unique implant ID into a user terminal 10(a)-10(d) or search for the particular tissue based on lot number, supplier or any other tissue information.

From operation 300, the process proceeds to operation 310, where the user is prompted, at user terminal 10(a)-10(d), to enter any required information. For instance, the user may be required to input updated storage conditions (e.g., storage temperatures) at specified times to be part of the inventory record 110, or any details related to the preparation of the tissue for implantation to be part of the preparation and usage record 120. Following implantation, the user may provide post-operative information to be part of the post-operative record 130.

From operation 310, the process proceeds to operation 320, where the updated tissue information is recorded in database 20 and associated with the unique implant ID. Thereafter, the updated tissue information is searchable, using the unique implant ID, via a user terminal 10(a)-10(d).

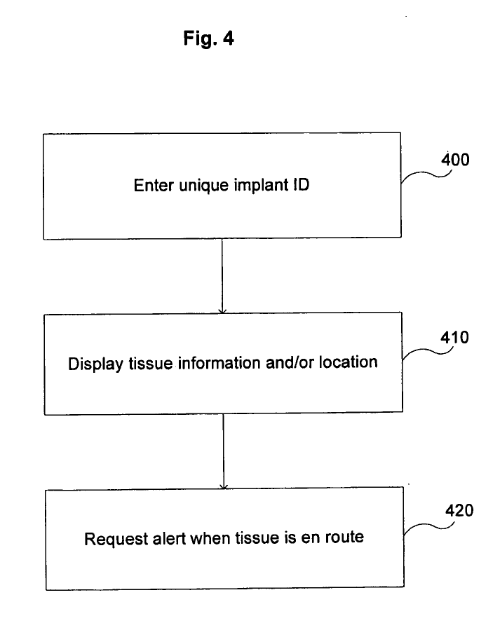

FIG. 4 is a flow diagram showing a method for searching tissue information based on a unique implant ID, according to one or more disclosed embodiments. When a user is not in possession of the tissue, but must obtain tissue information (e.g., a current location of the tissue), the user can search for tissue information at any user terminal 10(a)-10(d). At operation 400, the user inputs the unique implant ID at a user terminal 10(a)-10(d). As noted above, if the user does not have the unique implant ID, the user may search for a particular tissue using a lot number, a supplier or any other tissue information.

From operation 400, the process proceeds to operation 410, where the user terminal 10(a)-10(d) displays the tissue information and/or location obtained from database 20 via connection 30(a)-30(d). Any requested tissue information may be displayed at the user terminal 10(a)-10(d), as well as the location of the tissue or whether the tissue is en route to a particular location.

According to certain embodiments, the user may request an alert, at operation 420, to signal to the user when a tissue is en route to a particular location. Such an alert may be a pager alert; however, any conventional alert may be implemented without departing from the scope of the present disclosure. For example, a clinician can request that a page be sent to let him or her know when a tissue is en route to the operating room. As a result, the clinician is better able to stage the patient for implantation.

FIG. 5 is a schematic of a tissue container with a machine readable label bearing a unique implant ID affixed thereto, according to one or more disclosed embodiments. Container 500 is shown holding tissue 520. Container 500 may be any storage device or packaging storing and/or protecting tissue 520. Label 510, generated by barcode generator 50, is affixed to container 500, and includes a barcode 530, which is encoded based on the unique implant ID. Of course, the use of a barcode 530 is merely exemplary and any machine readable label bearing the unique implant ID for the tissue may be used (e.g., a 3D barcode, an RFID tag, a magnetically encoded tag, a chip, etc.).

Creating a unique implant ID at the point of intake eliminates manual processes required to establish tissue records from the point of intake through storage, implantation, records archival and recall management. Data accuracy and integrity are maintained as electronic records are created and associated with the unique implant ID. In addition, clinicians can use a user terminal 10(a)-10(d) to monitor what tissue has arrived, where the tissue currently is located, conditions of the tissue upon arrival, storage conditions and routing updates.

The methods and systems described herein solve the challenges that acute care hospitals face in managing tissue and biologics. The foregoing aspects provide the opportunity to generate an automated process that will help hospitals fully comply with the JCAHO regulations and contribute to improved patient outcomes. Specifically, automated management of tissue information ensures data integrity, thereby reducing tissue spoilage and providing improved patient safety with better clinical results.

Moreover, by prompting a user to input certain required information, a hospital or healthcare facility can avoid having missing documentation required by the JCAHO due to unintentionally overlooking tissue information or forgetting to monitor storage conditions. Since the tissue information, and the associated patient record, is stored on a centralized database 20, all tissue information is easily searchable, using the unique implant ID, and updatable.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

It is understood that the specific order or hierarchy of steps or operations in the processes disclosed is an illustration of exemplary approaches. Based upon design preferences, it is understood that the specific order or hierarchy of steps or operations in the processes may be rearranged. Some of the steps may be performed simultaneously. The accompanying method claims present elements of the various steps or operations in a sample order, and are not meant to be limited to the specific order or hierarchy presented.

What is claimed is:

1. A method for implant record intake using a unique implant ID, comprising:
inputting to a database a lot number of a tissue, corresponding to a donor of the tissue;
assigning a unique serial number to the tissue; and
creating the unique implant ID stored in the database, based on the lot number and the unique serial number.

2. The method of claim 1, further comprising:
generating a machine readable label encoded with the unique implant ID; and
affixing the machine readable label to a container of the tissue.

3. The method of claim 2, wherein the machine readable label is one of a barcode, a radio frequency identification tag, a 3D barcode, a magnetically encoded tag and a chip.

4. The method of claim 1, further comprising:
associating information about the tissue, input at one or a plurality of user terminals, with the unique implant ID to create an electronic record stored in the database.

5. The method of claim 4, wherein the electronic record is searchable in the database using the unique implant ID.

6. The method of claim 4, wherein said information about the tissue includes at least one of a location, a storage condition, a packaging condition, a delivery or routing update, implantation of the tissue and disposal of the tissue.

7. The method of claim 4, wherein said information about the tissue includes vendor information.

8. The method of claim 6, further comprising sending an alert to a user when the tissue is en route to a particular location.

9. The method of claim 1, wherein a location of the tissue is searchable using at least one of the lot number and the serial number.

10. A system for implant record intake using a unique implant ID, comprising:
at least one user terminal configured to input to a database a lot number of a tissue, corresponding to a donor of the tissue; and
a processing unit configured to assign a unique serial number to the tissue, and to create the unique implant ID stored in the database, based on the lot number and the unique serial number.

11. The system of claim 10, further comprising a machine readable label generator to generate a machine readable label encoded with the unique implant ID to be affixed to a container of the tissue.

12. The system of claim 11, wherein the machine readable label is one of a barcode, a radio frequency identification tag, a 3D barcode, a magnetically encoded tag and a chip.

13. The system of claim 10, further comprising:
a processing unit to associate information about the tissue, input at one or a plurality of user terminals, with the unique implant ID to create an electronic record stored in the database.

14. The system of claim 13, wherein the electronic record is searchable in the database using the unique implant ID.

15. The system of claim 13, wherein said information about the tissue includes at least one of a location, a storage condition, a packaging condition, a delivery or routing update, implantation of the tissue and disposal of the tissue.

16. The system of claim 13, wherein said information about the tissue includes vendor information.

17. The system of claim 15, further comprising a transmitting unit to transmit an alert to a user when the tissue is en route to a particular location.

18. The system of claim 10, wherein a location of the tissue is searchable using at least one of the lot number and the serial number.

19. A computer-readable medium storing instructions thereon for performing a method of implant record intake using a unique implant ID, the method comprising:
inputting to a database a lot number of a tissue, corresponding to a donor of the tissue;
assigning a unique serial number to the tissue; and
creating the unique implant ID in the database, based on the lot number and the unique serial number.
